(19) United States
(12) Patent Application Publication
(10) Pub. No.: US 2025/0357057 A1
(43) Pub. Date: Nov. 20, 2025

(54) RIVET CONTACT, ELECTRIC CONTACT, AND PRODUCTION METHOD OF ELECTRIC CONTACT

(71) Applicant: TANAKA KIKINZOKU KOGYO K.K., Tokyo (JP)

(72) Inventors: Sachihiro NISHIDE, Tomioka-shi (JP); Nobuhito YANAGIHARA, Tomioka-shi (JP); Hirofumi HOSHINO, Tomioka-shi (JP); Ryoto SATO, Tomioka-shi (JP)

(73) Assignee: TANAKA KIKINZOKU KOGYO K.K., Tokyo (JP)

(21) Appl. No.: 18/866,639

(22) PCT Filed: May 15, 2023
(86) PCT No.: PCT/JP2023/018067

§ 371 Date: Nov. 18, 2024

(30) Foreign Application Priority Data
May 19, 2022 (JP) 2022-082489

(51) Int. Cl. H01H 1/06; B21J 15/02; H01H 11/04; H01H 11/06

(52) U.S. Cl. CPC H01H 1/06; B21J 15/02; H01H 11/042; H01H 11/06

(57) ABSTRACT

An electric contact formed from electric contact members that include a rivet contact including a head portion containing a contact material in at least a part of a surface, and a foot portion that is inserted into a terminal member while supporting the head portion, and the terminal member that has an insertion hole for the foot portion of the rivet contact to be inserted, and fixes the rivet contact. In addition, in the rivet contact, a flange portion serving as a caulking margin and wider than the foot portion is formed between the head portion and the foot portion, and a counterbore hole for fitting the flange portion is formed in the terminal member. The electric contact of the present invention is manufactured in a good adhesion state with the flange portion of the rivet contact caulked to the counterbore hole of the terminal member.

### BACKGROUND OF THE INVENTION

### Field of the Invention

The present invention relates to a combination of a rivet contact having a rivet shape and a terminal member preferably applied to the rivet contact, and to an electric contact constituted of them. Particularly, the present invention relates to an electric contact that has good adhesion between a rivet contact and a terminal member, has excellent heat dissipation, and can ensure stable operation, and to a production method of the electric contact.

### Description of the Related Art

Rivet contacts having rivet shapes have been conventionally used as electric contacts (fixed contacts and movable contacts) mounted on relays, switches, and the like. A rivet contact includes a head portion that acts as an electric contact, and a foot portion to be fixed to a terminal member while supporting the head portion. As rivet contacts, in addition to rivet contacts (solid contacts) whose head portions and foot portions are entirely made from a contact material such as Ag alloy, rivet contacts (tension contacts) in which a contact material is applied to the entire head portions or a part, such as a surface, of the head portion, and a Cu-based material (base material) is applied to the other portions have been widely used in recent years for reducing material costs (Patent Documents 1 and 2).

When a rivet contact is fixed to a terminal member to constitute an electric contact, a foot portion of the rivet-type contact is inserted into an insertion hole drilled in advance in the terminal member, and thereafter the foot portion protruding from a rear side is subjected to compression processing (caulking processing). With this compression processing, the diameter of the foot portion in the insertion hole is expanded and adheres to a wall surface of the insertion hole, and the diameter of an end portion of the foot portion becomes larger than the insertion hole. FIG. 21 illustrates the above-described steps and the structure of the electric contact to be manufactured.

Incidentally, as a conventional concern about electric contacts such as relays, there is malfunction due to heat generation during operation. Although the electric conductivity of the materials constituting the contact material and base material of a contact member is relatively high, the materials still have properties as resistors and cannot completely suppress heat generation at the time of energization. The amount of heat generated in an electric contact is proportional to the contact resistance value of a contact material and the square of a current. Therefore, in high-capacity relays and the like that open and close high current, an increase in the amount of heat generated becomes a problem. When the amount of heat generated becomes excessively large, there is a risk of deformation or alteration of the contact material, and in the worst case, ignition, burnout, or the like may be caused.

In addition, one measure to address the problem of heat generation in electric contacts using rivet contacts is to improve the heat dissipation through improving the adhesion between a rivet contacts and a terminal member.

FIG. 23 shows photographs of a cross section of an electric contact in which a conventional rivet contact is fixed to a terminal member. When producing this electric contact, caulking processing that compresses a lower end of a foot portion of a rivet contact is performed in a manner similar to that in FIG. 21. From FIG. 23, it can be seen that, in this electric contact, a gap exists between a bottom surface of a head portion of a contact member and a surface of the terminal member. Such a gap observed in a conventional electric contact becomes a factor that inhibits the heat generated in the head portion from being transferred to the terminal member. Especially, in an electric contact that generates a high amount of heat, an oxide film is generated in the gap between the head portion that has become hot and the terminal member to inhibit heat transfer. When heat transfer to the terminal member is inhibited, the heat dissipation of the contact member via the terminal member will decrease, and it will become difficult to suppress temperature increase. Because of this, it is anticipated that eliminating the gap between the rivet contact, particularly its head portion, and the terminal member, to improve the adhesion can enhance the heat dissipation to suppress heat generation.

As an electric contact that improves the adhesion between a rivet contact and a terminal member, there is an electric contact described in Patent Document 3. The electric contact according to this prior art is characterized in that a counterbore hole is formed at a position of a terminal member where a head portion of a rivet contact is fixed. In addition, a foot portion is subjected to caulking processing in a state where the head portion of the rivet contact is fitted into this counterbore hole, and thereafter, compression processing is performed on the surrounding of the counterbore hole of the terminal member as illustrated in FIG. 22. This compression processing around the counterbore hole aims to improve the adhesion between the rivet contact and the terminal member.

### PRIOR ART DOCUMENT

### Patent Document

### Patent Document 1

Japanese Patent Application Laid-Open No. 5-282957

### Patent Document 2

Japanese Utility Model Registration No. 3098834

### Patent Document 3

Japanese Patent Application Laid-Open No. 2007-122931

### SUMMARY OF THE INVENTION

### Technical Problem

However, according to the study by the present inventors, the adhesion between the rivet contact and the terminal member is not necessarily sufficient in the above-described electric contact. When processing a portion of the terminal member surface around the rivet contact head portion, it is deemed that the adhesion of the processed portion is improved. However, it is deemed that it is difficult for this processing format to eliminate the gap between a bottom surface or side surface of the contact head portion and an internal surface of the counterbore hole.

Additionally, the production steps of the electric contact in the above-described Patent Document 3 require, in addition to the caulking processing of the foot portion of the rivet contact, a processing step of the portion of the terminal member surface around the rivet contact head portion. The former caulking processing of the foot portion is a conventionally performed step, and a further processing step is required in addition to the conventional step in the production steps of the electric contact in Patent Document 3. Such an additional processing step will affect the production efficiency of the electric contact.

As described above, at present, no sufficient measures have been taken to solve the problem of improving the adhesion of electric contacts to which rivet contacts are applied. Therefore, regarding an electric contact to which a rivet contact is applied, the present invention provides an electric contact in which the adhesion between the rivet contact and a terminal member is improved more than before and the rivet contact for constituting the electric contact, and clarifies the configuration of a terminal member compatible to the rivet contact. In addition, the present invention provides an electric contact obtained by combining the aforementioned electric contact members, and a production method of the electric contact.

### Solution to Problem

As described above, in electric contacts using conventional rivet contacts, the adhesion between head portions of the rivet contacts and terminal members is insufficient. Regarding this adhesion problem, the present inventors studied the countermeasure with the stress propagated to a head portion from a foot portion at the time of compression processing (caulking processing) on the foot portion for fixing of a rivet contact. In addition, the present inventors changed the respective configurations of the rivet contact and the terminal member, and arrived at a rivet contact including a portion to be subjected to plastic processing so as to adhere to a terminal member due to the stress of the aforementioned foot portion processing, and application of the terminal member corresponding to this rivet contact.

That is, the present invention that solves the above-described issue is a rivet contact including a head portion containing a contact material in at least a part of an upper surface, and a foot portion that is inserted into a terminal member while supporting the head portion, wherein a flange portion serving as a caulking margin and wider than the foot portion is formed between the head portion and the foot portion.

In the above-described rivet contact, it is preferable that a ratio of a width W of the flange portion to a diameter D of the foot portion be 1.1 or more and 4 or less.

Additionally, the present invention relates to a combination of electric contact members including a rivet contact including a head portion containing a contact material in at least a part of a surface, and a foot portion that is inserted into a terminal member while supporting the head portion, and the terminal member that has an insertion hole for the foot portion of the rivet contact to be inserted, and fixes the rivet contact, wherein, in the rivet contact, a flange portion serving as a caulking margin and wider than the foot portion is formed between the head portion and the foot portion, and a counterbore hole for fitting the flange portion is formed in the terminal member.

Also in this case, it is preferable that the ratio of the width W of the flange portion to the diameter D of the foot portion of the rivet contact be 1.1 or more and 4 or less. Additionally, it is preferable that the ratio of a height h of the flange portion of the rivet contact and a depth H of the counterbore hole of the terminal member be 0.5 or more and 5 or less.

In addition, the present invention provides an electric contact to which the above-described rivet contact is applied. This electric contact includes a rivet contact including a head portion containing a contact material in at least a part of an upper surface, and a foot portion that is inserted into a terminal member while supporting the head portion, and the terminal member that has an insertion hole for inserting the foot portion of the rivet contact, and fixes the rivet contact, the rivet contact being fixed to the terminal member with a lower end portion of the foot portion subjected to caulking processing after the foot portion is inserted into the insertion hole, wherein, in the rivet contact, a flange portion serving as a caulking margin and wider than the foot portion is formed between the head portion and the foot portion, a counterbore hole for fitting the flange portion is formed in the terminal member, and the flange portions is fitted into and caulked to the counterbore hole.

The electric contact of the present invention is excellent in the adhesion between the rivet contact and the terminal member. Specifically, it is preferable that an adhesion area ratio in an arbitrary region of a joining interface between a side surface and a bottom surface of the flange portion of the rivet contact, and a side surface and a bottom surface of the counterbore hole be 50% or more.

Further, the present invention relates to a production method of the electric contact using the above-described combination of the electric contact members. That is, it is the production method of the electric contact using the above-described combination of the electric contact members, the production method including a step of inserting the rivet contact into the terminal member, and a step of performing plastic processing on a lower end portion of the foot portion and the flange portion of the rivet contact to fix the rivet contact to the terminal member.

In the above-described method, in the step of performing plastic processing on the lower end portion of the foot portion and the flange portion of the rivet contact, the lower end portion of the foot portion of the rivet contact is compressed while the head portion and an upper surface of the flange portion of the rivet contact are restrained, thereby caulking the foot portion and caulking the flange portion to the counterbore hole of the terminal member.

Additionally, it is preferable to set a processing rate of the foot portion to 10% or more in the above-described step of performing plastic processing on the lower end portion of the foot portion and the flange portion of the rivet contact.

Additionally, in the production method of the electric contact of the present invention, although the adhesion between the rivet contact and the terminal member can be ensured in one step, i.e., the above-described compression processing of the foot portion, subsequent processing may be performed. That is, the present invention can include, after the above-described step of fixing the rivet contact to the terminal member, at least a step of performing compression processing on an upper surface of the flange portion of the rivet contact.

### Advantageous Effects of Invention

The rivet contact of the present invention includes the flange portion serving as a caulking margin, this flange portion is caulked to the counterbore hole of the terminal member, and thus the adhesion is improved. Accordingly, an electric contact with good heat dissipation can be obtained.

Additionally, the caulking processing of the flange portion of the rivet contact of the present invention can be advanced at the same time with the caulking processing of the foot portion of the rivet contact performed similarly as before. Since the rivet contact and the terminal member can be adhered to each other in this one step, the present invention can contribute to improvement of the production efficiency of an electric contact.

### BRIEF DESCRIPTION OF THE DRAWINGS

FIG. 1 is a diagram for describing the respective configurations of a rivet contact and a terminal member of the present invention;

FIG. 2 is a diagram for describing production steps of an electric contact using the rivet contact of the present invention;

FIG. 3 is a diagram illustrating a simulation result of the stress distribution in a production process of the electric contact of the present invention;

FIG. 4 is a diagram illustrating a simulation result of the stress distribution in a production process of a conventional electric contact;

FIG. 5 is a diagram illustrating a simulation result of the stress distribution in a production process of an electric contact of a conventional technique (Patent Document 3);

FIG. 6 is a diagram for describing the dimension of each portion of the rivet contact and the terminal member of the present invention;

FIG. 7 is a diagram illustrating an example of the simulation result on the relationship between a ratio (W/D) of a flange portion width to a foot portion width of the rivet contact and a processing rate;

FIG. 8 is a diagram illustrating an example of the simulation result on the relationship between a ratio (h/H) of a flange portion height of the rivet contact to a counterbore hole depth of the terminal member and the processing rate;

FIG. 9 shows photographs of the external appearance of an electric contact manufactured in Example 1;

FIG. 10 shows photographs of a cross section of the electric contact manufactured in Example 1;

FIG. 11 shows photographs of a joining interface at the time when the electric contact manufactured in Example 1 was heated at high temperature;

FIG. 12 shows photographs of a joining interface and an oxide layer at the time when a conventional electric contact, which is a comparative example, was heated at high temperature;

FIG. 13 is a graph illustrating the temperature change at the time when the electric contact of Example 1 and the conventional electric contact were energized;

FIG. 14 shows photographs of a cross section of an electric contact manufactured in Example 2;

FIG. 15 shows photographs of a cross section of an electric contact manufactured in Example 3;

FIG. 16 shows photographs of a cross section at the time when the electric contact manufactured in Example 3 was heated at high temperature;

FIG. 17 shows photographs of a cross section of an electric contact manufactured in Example 4;

FIG. 18 shows photographs of a cross section of an electric contact manufactured in Example 5;

FIG. 19 shows photographs of a cross section at the time when the electric contact manufactured in Example 5 was heated at high temperature;

FIG. 20 shows photographs of a cross section of an electric contact manufactured in Example 6;

FIG. 21 is a diagram for describing production steps of a conventional rivet contact and electric contact;

FIG. 22 is a diagram for describing a further processing step performed after caulking processing of the rivet contact in the conventional technique (Patent Document 3); and

FIG. 23 shows photographs illustrating a cross section of a conventional electric contact (comparative example) and a gap in a joining interface.

### DETAILED DESCRIPTION OF THE PREFERRED EMBODIMENTS

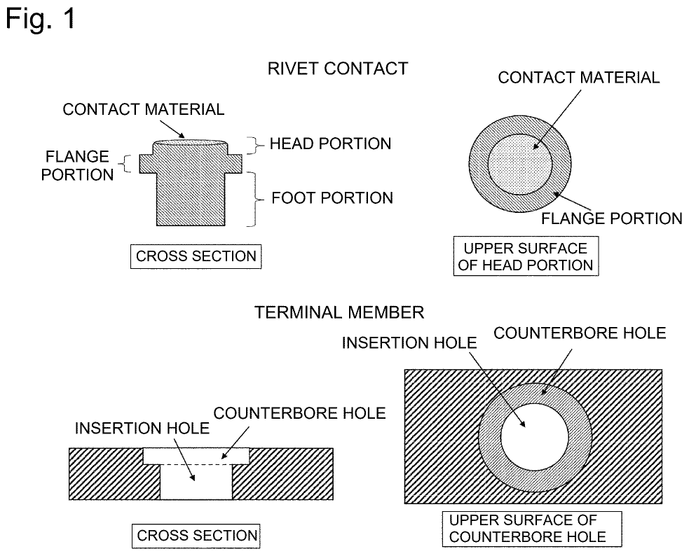

Hereinafter, details of the present invention will be described with embodiments thereof. FIG. 1 is a diagram for describing one aspect of a rivet contact and a terminal member of the present invention. Unlike conventional rivet contacts, the rivet contact of the present invention includes a flange portion serving as a caulking margin when fixed to the terminal member between a head portion containing a contact material and a foot portion. On the other hand, the terminal member has an insertion hole for the foot portion of the rivet contact to be inserted as before, and a counterbore hole is formed in a surface on the rivet contact head portion side. The flange portion of the rivet contact can be fitted into the counterbore hole of the terminal member.

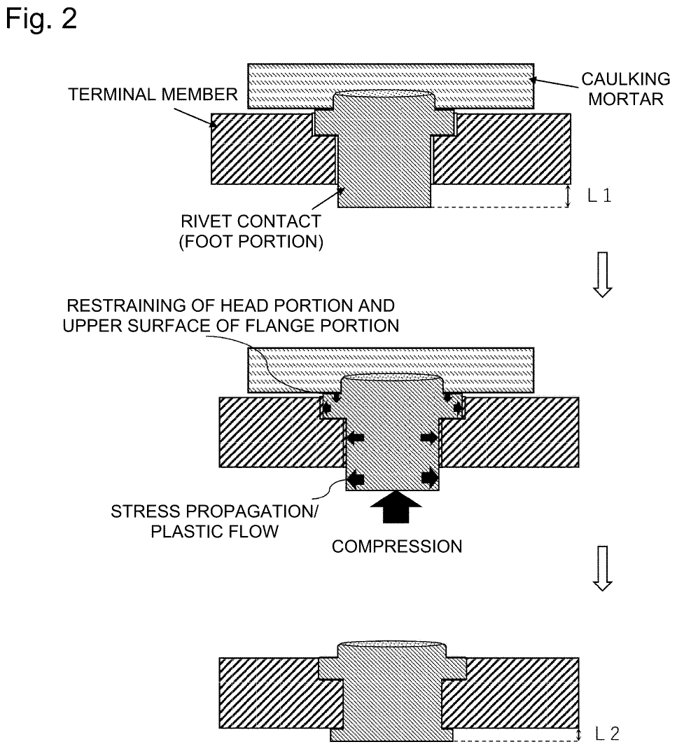

FIG. 2 is a diagram for describing production steps of the electric contact using the rivet contact and the terminal member in FIG. 1. In FIG. 2, the foot portion of the rivet contact is inserted into the insertion hole of the terminal member, and the flange portion is fitted into the counterbore hole to be in a state where the rivet contact is temporarily fixed to the terminal member. From this state, a jig such as a caulking mortar is abutted/fixed such that both the head portion and an upper surface of the flange portion of the rivet contact are restrained, and compression processing is performed on an end portion of the foot portion. This compression processing itself can be performed with the same processing method as conventional caulking processing of rivet contacts. In the compression processing of the foot portion end portion, a region of the foot portion protruding from a terminal surface adheres to the terminal surface while being crushed and deformed, and the diameter of the foot portion in the insertion hole of the terminal member is expanded to adhere to an inner wall. The above-described deformation/adhesion in the end portion of the foot portion, and the diameter expansion/adhesion inside the insertion hole are the same as those in the conventional caulking processing of rivet contacts.

In addition, as illustrated in FIG. 2, the flange portion of the rivet contact in a state where the flange portion is embedded in the terminal member via the counterbore hole will be subjected to stress propagation caused by the foot portion end portion as a stress source and the plastic flow caused by the stress propagation. In a compression processing step, since the head portion and the upper surface of the flange portion of the rivet contact are in the restricted state, the plastic flow occurs in a horizontal direction and a vertical direction, and the diameter of the flange portion is expanded. Accordingly, adhesion occurs between a side surface of the flange portion and an inner wall of the counterbore hole, and between a bottom surface of the flange portion and a bottom surface of the counterbore hole. As described above, in the present invention, with the compression processing of the foot portion end portion, the plastic processing (caulking processing) of the flange portion is performed in addition to the plastic processing (caulking processing) of the foot portion of the rivet contact, thereby improving the adhesion for the entire region where the rivet contact and the terminal member contact with each other.

Note that, in FIG. 2, for the protrusion length of the foot portion of the rivet contact from a rear surface of the terminal member, when the protrusion length before the compression processing is L1 and the protrusion length after the compression processing is L2, (L1-L2)/L1×100 (%), which is the change rate of the foot portion, is referred to as the processing rate in the present invention.

Here, in order to confirm the adhesion between the rivet contact and the terminal member of the present invention, the present inventors performed stress analyses by simulating the processing process for an electric contact using a rivet contact of the present invention, an electric contact using a conventional rivet contact, and an electric contact of the above-described Patent Document 3, and confirmed the above-described effect of improvement of the adhesion between the rivet contact and the terminal member. In these stress analyses, the shapes/dimensions of rivet contacts and terminal members are common, and the stress distribution after applying the same compression stress to the foot portion end portion to perform caulking processing was analyzed/mapped. Note that, in the analysis of the electric contact in Patent Document 3, the stress analysis was performed with the simulation until the compression processing was performed on the surrounding of the counterbore hole of the terminal member after performing the caulking processing on the foot portion. The simulation conditions applied to these stress analyses were as follows.

### (1) Rivet Contact

Present invention
   Head portion dimension: 5 mm in diameter×1 mm in height
   Flange portion dimension: 6 mm in diameter×1.1 mm in height
   Foot portion dimension: 4 mm in diameter×3 mm in length
Conventional technique and Patent Document 3
   Head portion dimension: 5 mm in diameter×1 mm in height
   Foot portion dimension: 4 mm in diameter×4 mm in length
In each case, the constituent materials are Ag for a contact material and Cu for a base material.

### (2) Terminal Member

Dimension: 30 mm×30 mm, and 3 mm in thickness
   Counterbore hole dimension for the present invention: 6 mm in diameter×1 mm in depth
   Counterbore hole dimension for Patent Document 3: 5 mm in diameter×0.2 mm in depth
In each case, the constituent material is Cu.

### (3) Compression Processing Conditions

The compression processing is performed on an end face of the foot portion with a lot pin (carbon steel) until the length (1 mm) of the foot portion protruding from the rear surface of the terminal member becomes half.

For Patent Document 3, the compression processing is performed until a 1 mm portion around the counterbore hole of the terminal member is pushed by 0.1 mm after the processing of the foot portion.

### (4) Analysis Software

ANSYS Mechanical (ver.2022R1) manufactured by ANSYS Inc.
Analysis type: time history response structural analysis (mesh creation conditions: programmed control (default))
As material parameters for analysis, the density/Poisson's ratio/Young's modulus/friction coefficient of the constituent materials of each member were input to perform the analysis.

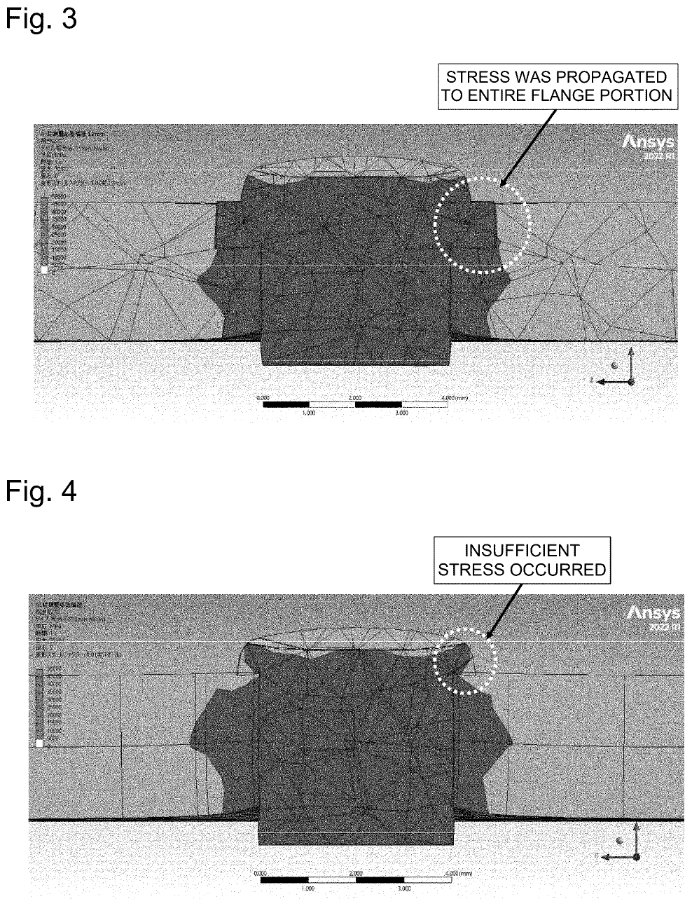

FIG. 3 to FIG. 5 illustrate analysis results of stress distribution at the time when the rivet contact of the present invention is joined to the terminal member based on the above-described conditions. In these analysis results, the stress required for adhesion between the rivet contact and the terminal member was assumed to be 5000 MPa or more, and the range where the stress of 5000 MPa occurred is shown in dark color in each diagram. Note that, assuming that the amount of plastic processing for adhesion between the rivet contact and the terminal member was 0.05 mm, the reference value of 5000 MPa was calculated from this deformation amount and the Young's modulus of Cu, which is the constituent material of the base material.

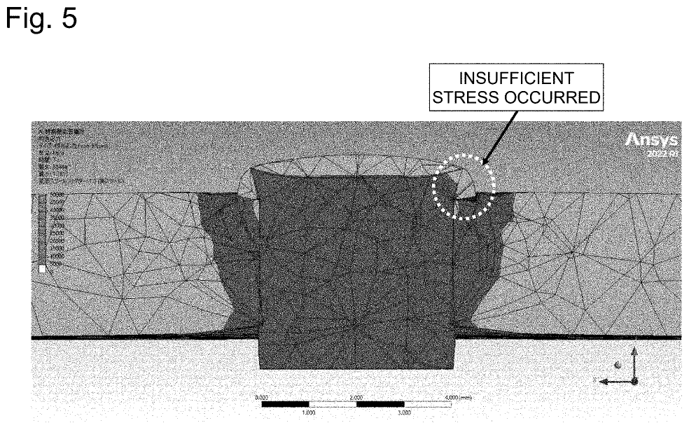

From FIG. 3, it can be confirmed that, in the embodiment of the electric contact to which the rivet contact of the present invention was applied, sufficient stress was generated in the entire flange portion, and the adhesion to the inner wall of the counterbore hole of the terminal member was ensured. On the other hand, in the electric contact using a general rivet contact in FIG. 4, insufficient stress was observed in a side surface and a bottom surface of a head portion. In addition, also in the electric contact in which the surrounding of the counterbore hole was compressed as in Patent Document 3 in FIG. 5, although the range of prescribed stress was wider compared with the electric contact using the general rivet contact, insufficient stress occurred in the head portion of the rivet contact.

As can also be seen from the above-described simulation results, in the rivet contact including the flange portion of the present invention, it is possible to cause the flange portion to highly adhere to the terminal member, while the flange portion is used as a caulking margin. In addition, fixing of the rivet contact of the present invention to the terminal member can be achieved with the same one step as that in conventional rivet contacts.

The rivet contact of the present invention can be basically made similar to conventional rivet contacts in terms of the constituent materials and the configurations of the head portion and foot portion. It is sufficient that a contact material is coupled to a part of a surface of the head portion. Additionally, after joining the rivet contact to the terminal member, when a contact pair (a combination of a movable contact and a fixed contact, or the like) is formed, it is sufficient that the head portion can come into contact with the opposing electric contact. In addition, it is sufficient that the foot portion has a shape that can be inserted into the insertion hole of the terminal member, and is formed to support the head portion. Note that the rivet contact and the electric contact of the present invention can be applied to both movable contacts, such as relays, and fixed contacts, and the present invention is applied to either or both of movable contacts and fixed contacts.

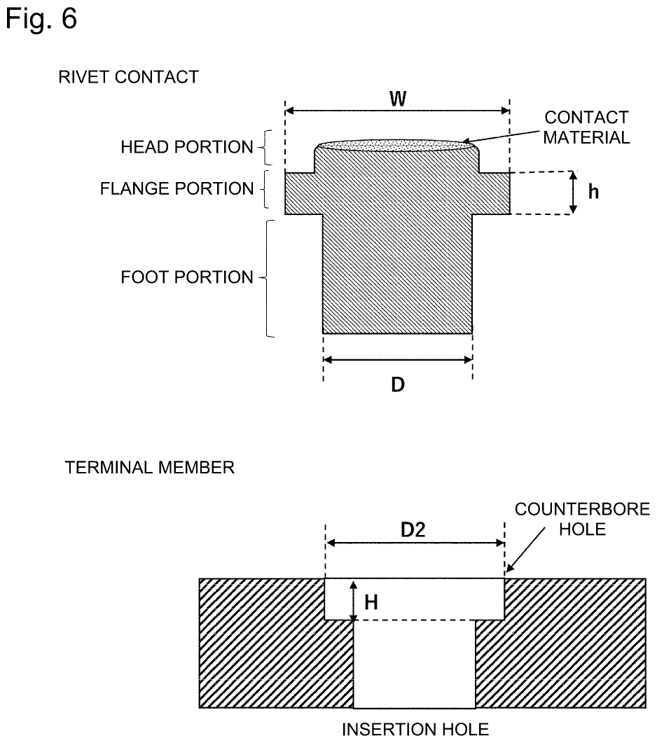

On the other hand, the flange portion, which characterizes the rivet contact of the present invention, is wider than the foot portion and formed between the head portion and the foot portion. Regarding this flange portion being wider than the foot portion, it is preferable that, when the width of the flange portion is W and the diameter of the foot portion is D, the ratio W/D between them be 1.1 or more and 4 or less (refer to FIG. 6). W/D can be set within the aforementioned range based on the constituent materials (base materials) of the foot portion and the flange portion, the length of the foot portion, specific numerical dimensions, and the like. However, when the value of W/D is excessively large, that is, when the flange portion is excessively wider than the foot portion, stress propagation to the flange portion at the time of processing may become insufficient, and the adhesion to the terminal member (counterbore hole) may be insufficient. It is more preferable that W/D be 1.1 or more and 2.5 or less.

Note that, although the side surface of the flange portion may be perpendicular, or the side surface may be inclined and tapered. The width (W) of the flange portion in that case is the width of the bottom surface that contacts with the terminal member counterbore hole. Additionally, regarding the dimension of the head portion, although it is necessary to make the width of the head portion smaller than that of the flange portion so that the flange portion serves as the caulking margin, there are no other dimensional restrictions. The width of the head portion may be the same as the diameter of the foot portion, or may be smaller or larger than the diameter of the foot portion. Further, since the length of the foot portion is set in accordance with the terminal member determined with the specification dimensions of relays and the like, there is particularly no restriction.

Regarding the constituent material of the rivet contact, the contact material usually used for relay contacts and the like is used as the contact material of the head portion. Ag-based contact materials are known as preferred contact materials for relay contacts and the like. Specifically, pure Ag and Ag alloys (a Ag—Ni alloy, a Ag—Cu alloy, and the like) can be listed as Ag-based contact materials. Additionally, in addition to a solid solution alloy, oxide-dispersed Ag alloys (a Ag—SnO₂ based alloy, a Ag—SnO₂—In₂O₃ based alloy, a Ag—ZnO based alloy, and the like) can also be applied as Ag alloys. Additionally, the base material constituting the head portion, the flange portion, and the foot portion other than the contact material is not particularly limited as long as the base material is a conductive metal/alloy. As the base material of the rivet contact, Cu-based materials such as Cu and Cu alloys (a Cu—Ni alloy, a Cu—Sn alloy, and the like) are often used. Since Cu-based materials have good conductivity and good processability, it is possible to form a good joining state when caulking the above-described rivet contact to the terminal member. Note that it is preferable that the head portion, the flange portion, and the foot portion other than the contact material be integrally formed. Additionally, it is sufficient that the contact material is joined to at least a part of the surface of the head portion, and there is particularly no restriction for the thickness of the contact material. The type and dimensions of the contact material are determined based on the specifications of a relay and the like on which an electric contact is mounted.

The terminal member combined with the rivet contact of the present invention to constitute an electric contact has an insertion hole for inserting the rivet contact as in conventional techniques. In addition, a counterbore hole for fitting the flange portion of the rivet contact is formed in the terminal member of the present invention. Two or more insertion holes and counterbore holes may be formed in the terminal member.

The counterbore hole is formed corresponding to the shape/dimension of the flange portion of the rivet contact. The inner diameter of the counterbore hole is sufficient as long as the flange portion can be received. It is preferable that the ratio (W/D2) of an inner diameter D2 of the counterbore hole to the width W of the flange portion be ½ or more and less than 1/1 (refer to FIG. 6). It is more preferable that W/D2 be 7/10 or more and less than 1/1.

Additionally, it is preferable that, regarding the relationship between the depth H of the counterbore hole and the height h of the flange portion of the rivet contact, h/H be 0.5 or more and 5 or less (refer to FIG. 6). It is more preferable that the range of this h/H be 0.8 or more and 2.2 or less. Note that, when h/H exceeds 1, although there may be a step between the flange portion and the terminal member surface after joining the rivet contact to the terminal member, the presence or absence of the step does not particularly cause any problems in the function of the electric contact. Additionally, as will be described later, in the present invention, since the processing step of pressurizing/compressing the upper surface of the flange surface may be additionally performed after joining of the rivet contact, the step can also be reduced or eliminated even if h/H exceeds 1.

Similar materials as those for conventional terminal members are also applied to the constituent materials of the terminal member. Specifically, a Cu-based material, an Fe-based material, and the like are used. Additionally, these metals may be plated (Sn plating, Ni plating, Ag plating, or the like).

The rivet contact and the terminal member described above constitute the combination for the electric contact of the present invention. In addition, the electric contact is manufactured by the above-described method using this combination for the electric contact. In the above-described production method of the electric contact of the present invention, the foot portion of the rivet contact is compressed while the head portion and the upper surface of the flange portion of the rivet contact are restrained, thereby caulking the foot portion and the flange portion of the rivet contact to be joined and fixed to the terminal member. In the restraining of the head portion and the upper surface of the flange portion of the rivet contact, a jig, such as a caulking mortar, which includes a concave portion having a shape that fits the head portion and the upper surface of the flange portion of the rivet contact is abutted to the rivet contact, and the jig is fixed so as not to move. Although it is allowed for the jig, such as a caulking mortar, to apply stress for restraining the head portion of the rivet contact, there is no need to apply stress that would process the head portion. The present invention is the method of improving the adhesion between the rivet contact and the terminal member, without processing the head portion, particularly the contact material.

The caulking processing of the foot portion of the rivet contact and the processing of the flange portion are performed with compression processing of the end face of the foot portion. The compression processing is performed with a compression member, such as a lot pin, abutted to and pressurizing the end face of the rivet contact foot portion. A surface of the compression member may be flat, or may have a concave portion that suppresses shifting of the rivet contact foot portion. The adhesion between the flange portion and the counterbore hole may be improved with the use of the compression member having the concave portion.

The pressurizing force for the compression processing of the rivet contact foot portion can be adjusted with the processing rate (the crushing amount) of the foot portion protruding from the rear surface of the terminal member. The significance of the processing rate has been described above. In the present invention, the deformation/diameter expansion of the rivet foot portion and the flange portion are caused simultaneously due to the propagation of compression stress and the plastic flow applied by this one step. In addition, in order to deform the flange portion to adhere to the inner wall of the counterbore hole of the terminal member, it is preferable to perform the compression processing such that the processing rate is 10% or more. It is more preferable that the processing rate be 30% or more, and it is further preferable that the processing rate be 50% or more. Note that, in the compression processing of the foot portion, pressurizing may be performed until the deformed foot portion end portion is buried in the terminal member. Thus, up to 100% is allowed as the upper limit of the processing rate.

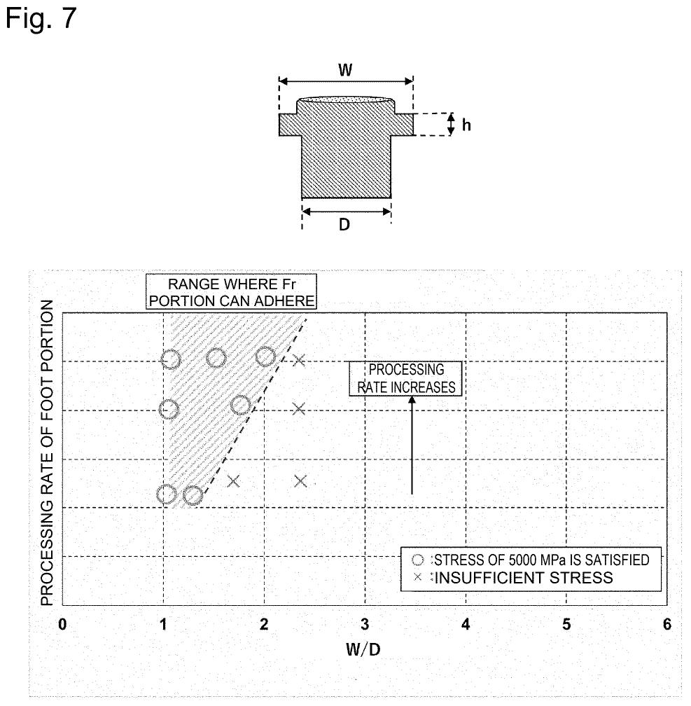

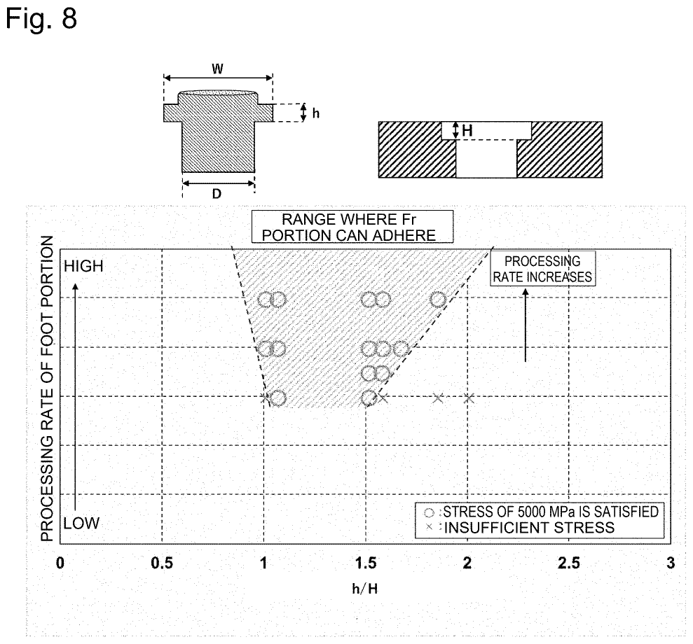

It can also be estimated from the results of the simulations performed on the rivet contacts and terminal members with specific dimensions/materials described above that the deformability of the flange portion of the rivet contact is improved when the processing rate of the foot portion is increased. FIGS. 7 and 8 illustrate the results of studying the relationship between the processing rate and the dimensions of the flange portion and the counterbore hole in the above-described simulation results. FIG. 7 is a diagram illustrating the setting range of the ratio (W/D) of the width W of the flange portion of the rivet contact to the diameter D of the foot portion at the time when the processing rate during the foot portion compression is increased. Additionally, FIG. 8 is a diagram illustrating the setting range of the ratio (h/H) of the height h of the flange portion of the rivet contact to the depth H of the counterbore hole at the time when the processing rate during the foot portion compression is increased. From these diagrams, it can be seen that increasing the processing rate of the foot portion during the processing widens the setting ranges of the ratio (W/D) of the width W of the flange portion to the diameter D of the foot portion and the ratio (h/H) of the height h of the flange portion to the depth H of the counterbore hole.

In the production method of the electric contact of the present invention, both the foot end portion and the flange portion of the rivet contact can be caulked to the terminal member with the above-described processing step of the foot portion, and accordingly, the rivet contact can be firmly joined/fixed. After performing this compression processing step one time, there is no need to perform processing of the terminal surface as in the conventional technique (Patent Document 3).

However, it is possible to add an additional processing step for the flange portion, after fixing the rivet contact to the terminal member. For example, when the height of the flange portion of the rivet contact is greater than the depth of the counterbore hole of the terminal member (h>H), a step may be formed between the flange portion and the terminal member. In order to reduce or eliminate this step, at least the flange upper surface may be additionally subjected to compression processing. Additionally, in some cases, it is also possible to further increase the adhesion between the flange portion and the terminal member when the additional compression processing is performed. In this additional processing step, at least only the upper surface portion of the flange portion is subjected to the compression processing so that the plastic processing is performed on the flange portion. However, both the upper surface portion and the head portion of the flange portion may be compressed within a range that does not deform the head portion. As a specific method, the flange portion can be processed with the rivet contact pressurized with a compression member such as a caulking mortar used as described above, or with the upper surface of the flange portion pressurized with a compression member having a shape corresponding to the upper surface of the flange portion.

In the electric contact that is constituted of the rivet contact and the terminal member manufactured by the method described above, the side surface and the bottom surface of the flange portion of the rivet contact are in a state where they highly adhere to the inner wall and the bottom surface of the counterbore hole of the terminal member. As for this adhesion state, when observing an arbitrary region of the joining interface between the side surface of the flange portion and the side surface (inner wall) of the counterbore hole, and the joining interface between the bottom surface of the flange portion and the bottom surface of the counterbore hole, it is preferable that the adhesion area ratio in the observed region be 50% or more, and it is more preferable that the adhesion area ratio be 70% or more. The adhesion area ratio is the percentage of the area of the range where the flange portion and the counterbore hole contact with each other without a gap, on the basis of the area of the entire region where the flange portion and the counterbore hole contact with each other. In the present invention, the gap is a space having a width of 3 μm or more. The area ratio of the gap in the joining interface is measured, “100 (%)—the measured area ratio of the gap” is calculated, and thus the adhesion area ratio can be obtained. Additionally, when measuring the area ratio of the gap, it is simple to observe an arbitrary region of a cross section of the electric contact with a metallurgical microscope or a scanning electron microscope (SEM). In addition, the length of the joining interface and the length of the gap in an observation image are measured, and the ratio of the two can be used as the area ratio of the gap. When observing the joining interface, it is preferable to set an observation region for each of two locations, i.e., the side surface and the bottom surface of the flange portion. Additionally, it is preferable to observe a plurality of locations in each portion.

Additionally, whether or not a gap exists in the joining interface between the rivet contact and the terminal member can be confirmed from whether or not an oxide layer is formed at the joining interface when the electric contact is heated at high temperature. In this case, when the electric contact is heated at 200° C. or more in an atmospheric/oxidizing atmosphere, the surfaces of the terminal member and/or the rivet contact are oxidized to form an oxide in the gap that communicates with the atmosphere. Since such an oxide is relatively easier to observe than the gap itself, whether or not the gap exists can be confirmed. Similar to the above-described observation method of the gap, the area ratio of the measured oxide layer can be used as the area ratio of the gap.

### Examples

Example 1: A specific example of a rivet contact and an electric contact of the present invention will be described. The constituent materials of the rivet contact of the present example are a Ag-based oxide material for a contact material, and Cu for a base material of the foot portion and the flange portion. This rivet contact was manufactured with the contact material and the base material processed into a contact shape by header processing. Additionally, the terminal member was made of Cu, a Cu plate was cut to form a counterbore hole, and the center of the counterbore hole was drilled to form an insertion hole. The dimensions of each portion of the rivet contact and the terminal member were as follows.

### Rivet Contact

$$Head portion dimension : 5 mm in diameter \times 1 mm in height$$

$$Flange portion dimension : 7 mm in diameter ( width W ) \times 1 mm in height ( H )$$

$$Foot portion dimension : 4 mm in diameter ( D ) \times 3 mm in length$$

$$W / D = 1.75$$

### Terminal Member

$$Overall dimension : 40 mm \times 16 mm , and 3 mm in thickness$$

$$Counterbore hole dimension : 7.1 mm in diameter \times 1 mm in depth ( h )$$

$$h / H = 1.$$

In addition, the rivet contact was inserted into the terminal member, a caulking mortar having a concave portion that can fit to the entire head portion was put on the head portion, and the head portion of the rivet contact was fixed and restrained with the caulking mortar. In this state, a lower end portion of the foot portion was pressurized with a lot pin to compress the foot portion. In the present example, compression was performed with the processing rate of the foot portion after compression being 90%.

Additionally, here, an electric contact using a rivet contact having a conventional shape was also produced as a comparative example. The same materials as in the example were used for the contact material and the base material. The dimensions of this rivet contact were set as follows, and this rivet contact was manufactured by the same processing method as in the example.

### Rivet Contact

$$Head portion dimension : 5 mm in diameter \times 1 mm in height$$

$$Foot portion dimension : 4 mm in diameter \times 4 mm in length$$

### Terminal Member

$$Overall dimension : 40 mm \times 16 mm , and 3 mm in thickness$$

In addition, similar to Example 1, the rivet contact was inserted into the terminal member (without a counterbore hole), and the foot portion was compressed and joined. Similar to the example, the processing rate of compression of the foot portion was set to 90%.

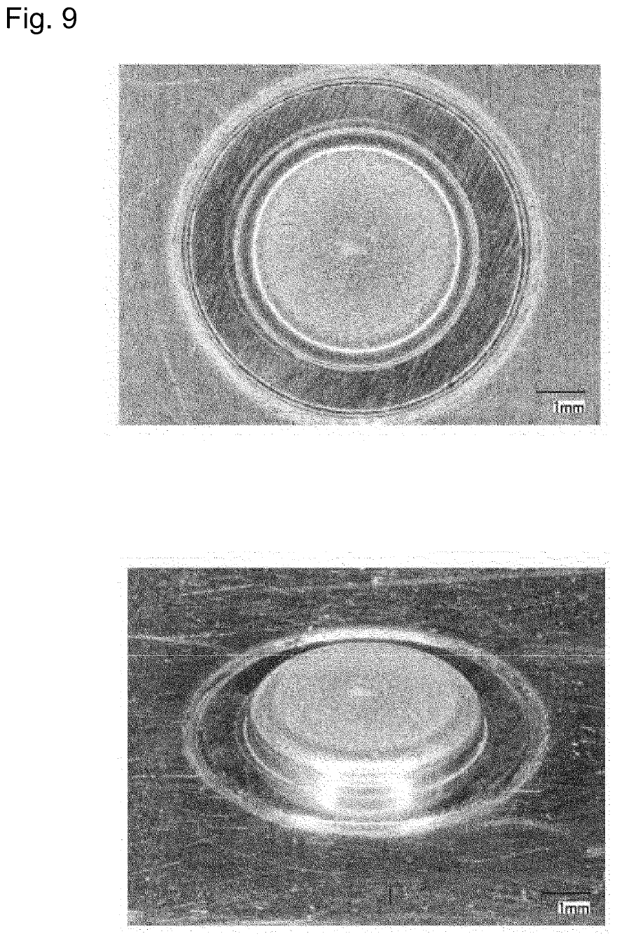

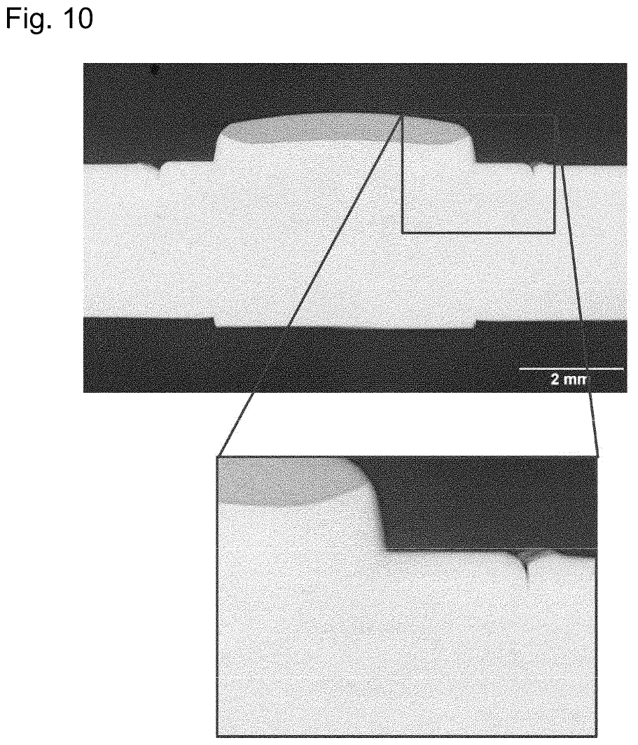

FIG. 9 shows photographs of the external appearance of the produced electric contact of Example 1. Additionally, this electric contact was cut along the center line of the head portion of the rivet contact, and a cross section was observed. FIG. 10 shows photographs of the cross section and its partial enlargement.

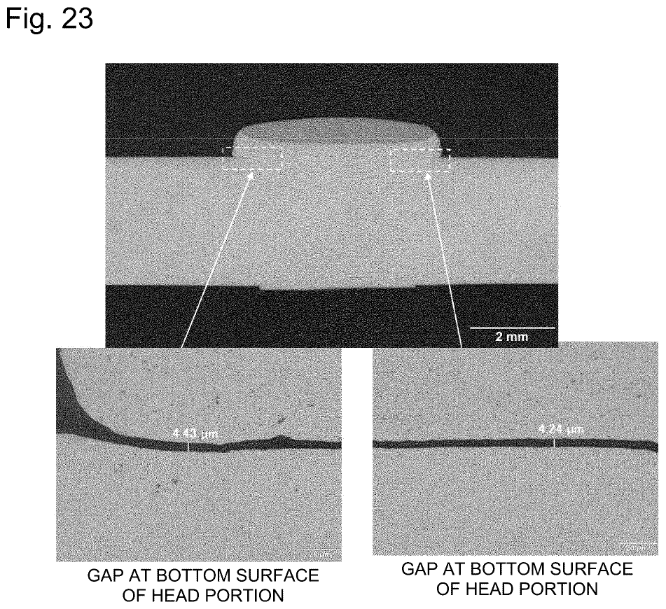

As can be confirmed from FIG. 10, since a gap was hardly observed in the joining interface between the flange portion and the foot portion in the electric contact of Example 1, it can be seen that very good adhesion was obtained. On the other hand, the cross-sectional photograph of the electric contact of the comparative example is already described FIG. 23. In the electric contact using the conventional rivet contact, linear gaps were confirmed in the joining interfaces at the bottom portion of the head portion and the foot portion side surface of the rivet contact. This gap had a width of approximately 4 μm. Note that the adhesion area ratio in the joining interface between the flange portion of the rivet contact and the counterbore hole in the present example was 95%. On the other hand, when the adhesion area ratio in the joining interface between the bottom surface of the head portion and a surface of a supporting member was measured for the rivet contact having a conventional shape, which is the comparative example, the adhesion area ratio was almost 0%, and a gap of 3 μm or more was generated in the substantially entire surface. Therefore, it is deemed that there is a clear difference in adhesion between the present example and the comparative example.

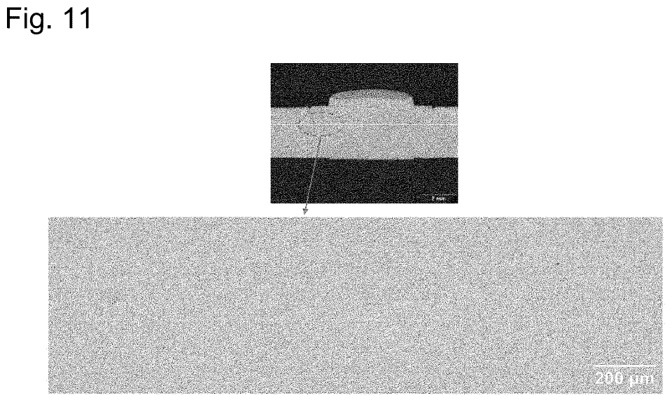

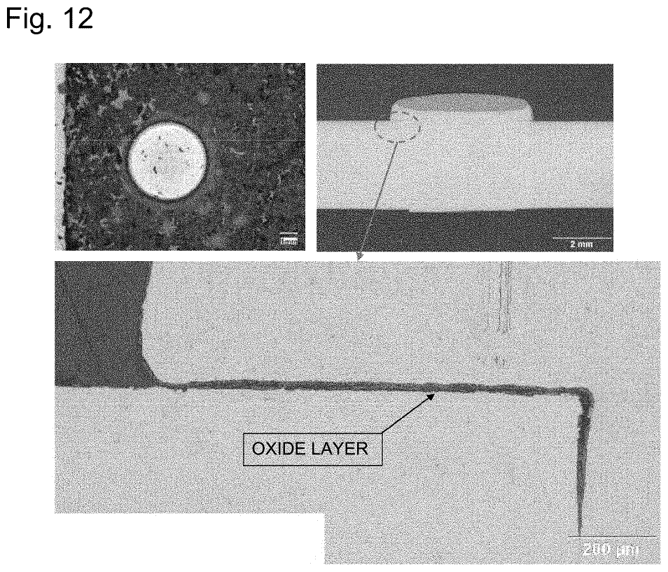

Further, whether or not an oxide was formed in the joining interface upon heating at high temperature was also confirmed for the electric contacts of Example 1 and the comparative example. In this heating test, the electric contacts were heated at 500° C. for 60 min (in the atmosphere) in a tubular furnace, and thereafter cross sections were observed in a manner similar to the above. The results are shown in FIGS. 11 and 12, in the electric contact (FIG. 12) of the comparative example, a black oxide layer was formed in the vicinity of the joining interface at the bottom portion of the head portion of the rivet contact. On the other hand, in the electric contact (FIG. 11) of the example, formation of an oxide layer was not observed at all at the joining interface. Therefore, the adhesion area ratio was estimated based on the region where this oxide layer existed. The area ratio of the region where the oxide layer at the joining interface was observed was measured, and “100 (%)—the measured area ratio of the oxide layer” was calculated to obtain the adhesion area ratio based on existence of the oxide. The adhesion area ratio based on this oxide layer was 93.5%.

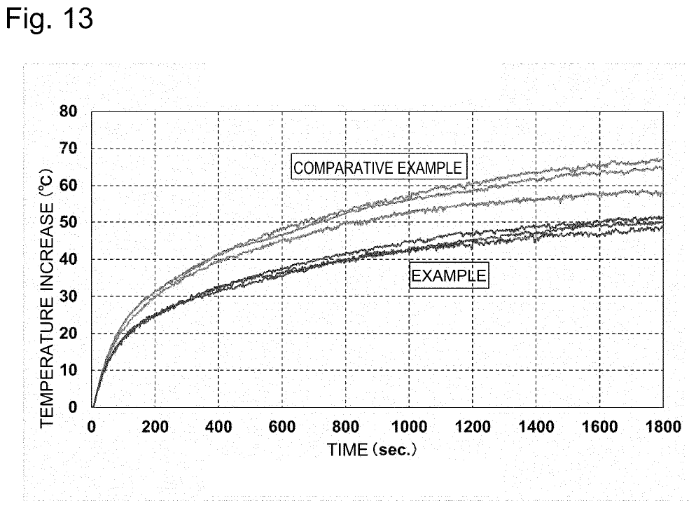

Next, the electric contacts of the example and the comparative example were incorporated in a relay, and the heat transfer performance of the electric contacts at the time when the relay was energized was confirmed. In this energization test, a relay having a double-break structure that includes two contact pairs of a movable contact and a fixed contact was prepared, and the electric contacts of the example and the conventional example were joined to a fixed terminal and a movable terminal. In addition, each contact was connected and energized at DC100V and 200A. In addition, the temperature of the movable terminal was measured as the temperature of the electric contact, and the temperature measurement was performed until 30 min (1800 sec) elapsed from the start of energization. This energization test was performed on three samples. The evaluation results are illustrated in FIG. 13.

From FIG. 13, it can be seen that the temperature increase in the electric contact of the example was clearly reduced compared to the electric contact of the comparative example. The temperature increase value after 30 min of energization was reduced by 21% on average in the example compared to the comparative example. Although it is deemed that the rivet contact of the example has a larger volume than that in the comparative example due to the existence of the flange portion, and this has the effect of improving heat dissipation, it is deemed that the heat transfer effect obtained by the improvement in the adhesion between the rivet contact and the terminal member contributes to suppression of temperature increase in the contact.

Example 2: In this example, a rivet contact was manufactured in which the ratio (W/D) of the width W of the flange portion to the diameter D of the foot portion was 1.1. The contact material of the rivet contact, the base material of the foot portion and the flange portion, and the material of the terminal member were the same as those in Example 1. The dimensions of each portion of the rivet contact and the terminal member of the present example were as follows.

### Rivet Contact

$$Head portion dimension : 5 mm in diameter \times 1 mm in height$$

$$Flange portion dimension : 3.3 mm in width ( W ) \times 1.1 mm in height ( H )$$

$$Foot portion dimension : 3 mm in diameter ( D ) \times 2.5 mm in length$$

$$W / D = 1.1$$

### Terminal Member

$$Overall dimension : 40 mm \times 16 mm , and 3 mm in thickness$$

$$Counterbore hole dimension : 3.4 mm in diameter \times 1 mm in depth ( h )$$

$$h / H = 1.1$$

In addition, similar to Example 1, the rivet contact was inserted into the terminal member, and the lower end portion of the foot portion was pressurized/compressed while the head portion of the rivet contact was restrained. In the present example, the processing rate of the foot portion after compression was set to 30%.

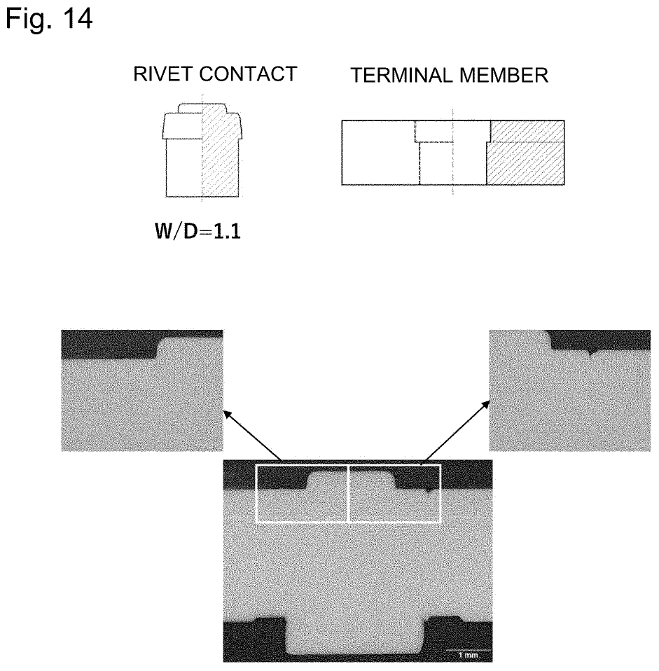

The electric contact of Example 2 was cut along the center line of the head portion of the rivet contact, and a cross section was observed. FIG. 14 shows photographs of the cross section and its partial enlargement. Also in the electric contact of the present example, a gap was hardly observed in the joining interface between the flange portion and the foot portion, and it can be seen that very good adhesion was obtained. When the adhesion area ratio in the joining interface between the flange portion of the rivet contact and the counterbore hole was measured, the adhesion area ratio was 85.7%.

Example 3: In this example, a rivet contact was manufactured in which the ratio (W/D) of the width W of the flange portion to the diameter D of the foot portion was 4.0. The materials of the rivet contact and the terminal member were the same as those in Example 1. In addition, similar to Example 1, the rivet contact was inserted into the terminal member, and the lower end portion of the foot portion was pressurized/compressed while the head portion of the rivet contact was restrained. In the present example, the processing rate of the foot portion after compression was set to 10%.

### Rivet Contact

$$Head portion dimension : 1.5 mm in diameter \times 0.3 mm in height$$

$$Flange portion dimension : 4.8 mm in width ( W ) \times 0.3 mm in height ( H )$$

$$Foot portion dimension : 1.2 mm in diameter ( D ) \times 1.5 mm in length$$

$$W / D = 4.$$

### Terminal Member

$$Overall dimension : 40 mm \times 16 mm , and 0.7 mm in thickness$$

$$Counterbore hole dimension : 4.9 mm in diameter \times 0.2 mm in depth ( h )$$

$$h / H = 1.5$$

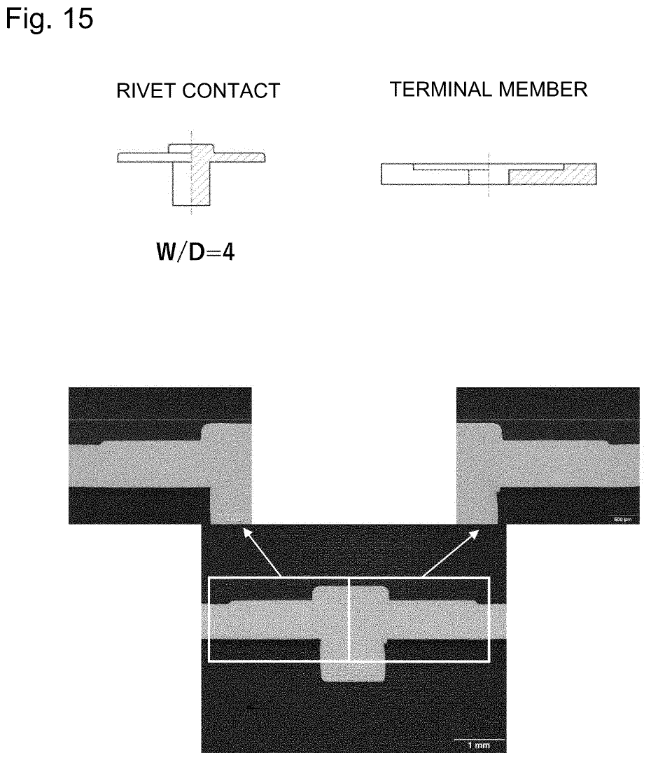

FIG. 15 shows photographs of a cross section of the electric contact of Example 3 and its partial enlargement. Also in the electric contact of the present example, a gap was hardly observed in the joining interface between the flange portion and the foot portion, and very good adhesion was obtained. The adhesion area ratio in the joining interface between the flange portion of the rivet contact and the counterbore hole was 99.6%.

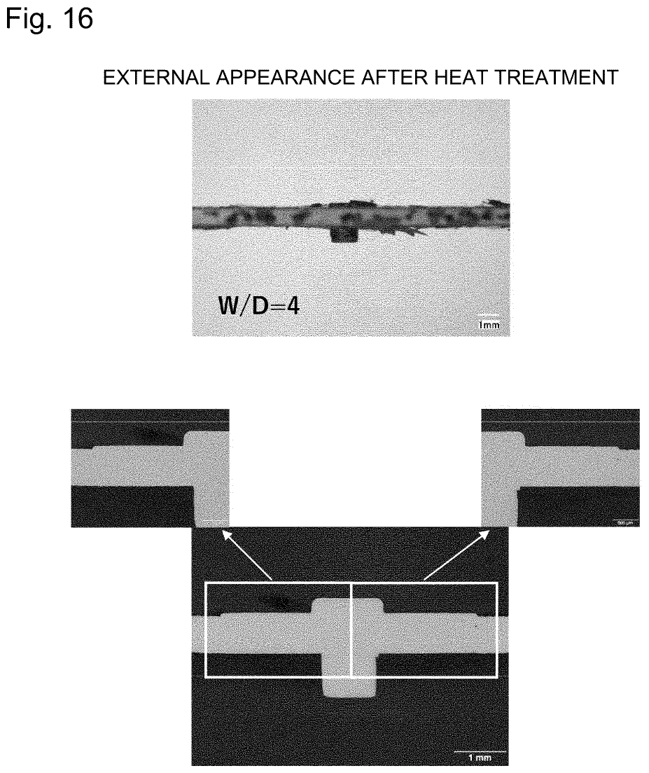

Whether or not an oxide layer was formed at the joining interface upon heating at high temperature was confirmed for the electric contact of Example 3. The heating conditions were similar to those in Example 1, and heating was performed for 60 min (in the atmosphere) at 500° C. The result of observation of the cross section is shown in FIG. 16. Also in Example 3, formation of an oxide layer was hardly observed at the joining interface as in Example 1. The adhesion area ratio based on the oxide in the present example was 98.8%. This value is a value that can be approximated to the value (99.6%) of the adhesion area ratio measured through observation of the gap as described above.

Example 4, Example 5: In these examples, rivet contacts having the following dimensions was manufactured in which the ratio (h/H) of the flange portion height of the rivet contact to the counterbore hole depth of the terminal member was 0.5. The materials of the rivet contact and the terminal member were the same as those in Example 1. In addition, similar to Example 1, the rivet contact was inserted into the terminal member, and the lower end portion of the foot portion was pressurized/compressed while the head portion of the rivet contact was restrained. In these examples, the processing rate of the foot portion after compression was set to 20% (Example 4) and 10% (Example 5).

### Rivet Contact

$$Head portion dimension : 5 mm in diameter \times 1 mm in height$$

$$Flange portion dimension : 7 mm in width ( W ) \times 1.1 mm in height ( H )$$

$$Foot portion dimension : 4 mm in diameter ( D ) \times 3 mm in length$$

$$W / D = 1.75$$

### Terminal Member

$$Overall dimension : 40 mm \times 16 mm , and 4.2 mm in thickness$$

$$Counterbore hole dimension : 7.1 mm in diameter \times 2 \text{.2} mm in depth ( h )$$

$$h / H = 0.5$$

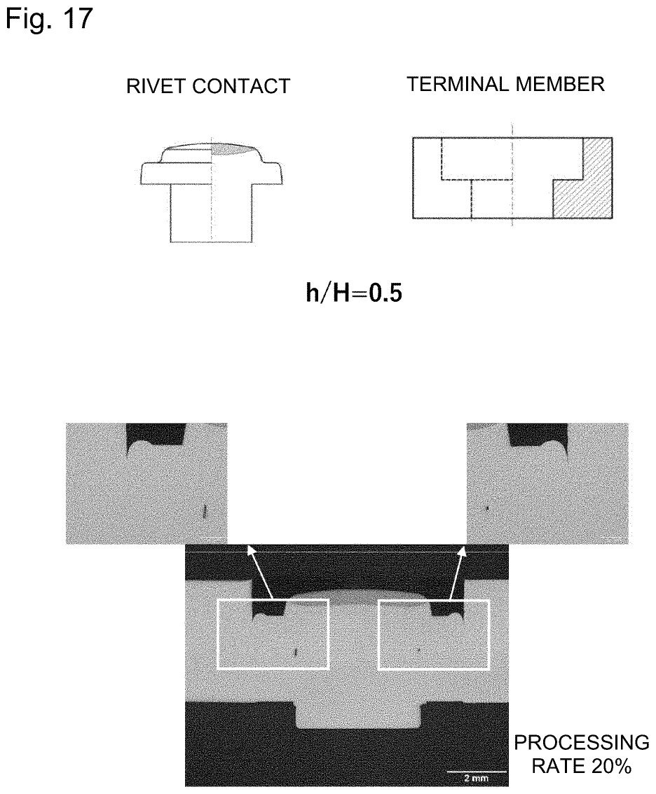

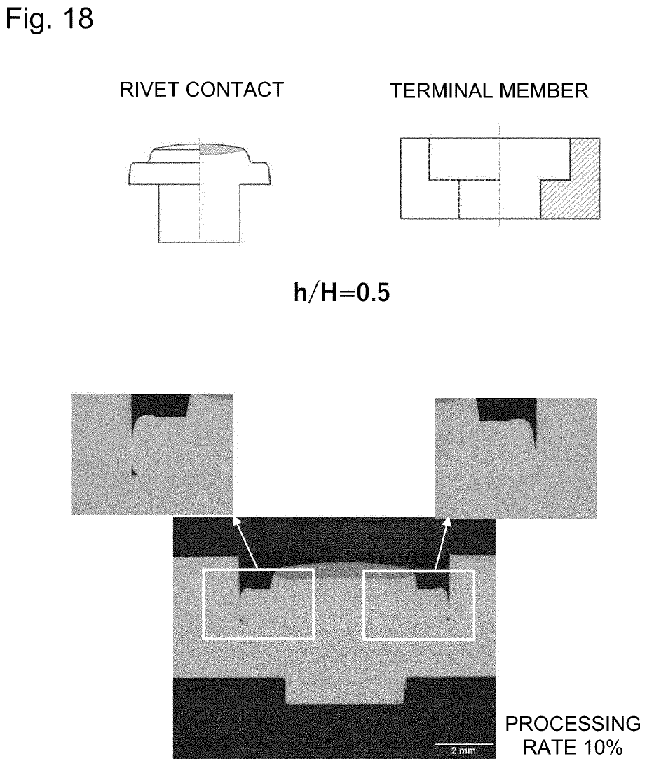

FIG. 17 and FIG. 18 show photographs of cross sections of the electric contacts and their partial enlargement in these examples. In these examples, although there was a gap in the vicinity of a corner of the flange portion, there is no gap in the joining interface at the bottom surface of the flange portion, and it was confirmed that there was good adhesion. The adhesion area ratio in the joining interface between the flange portion of the rivet contact and the counterbore hole was 85.0% in Example 4 (the processing rate 20%), and 71.7% in Example 5 (the processing rate 10%).

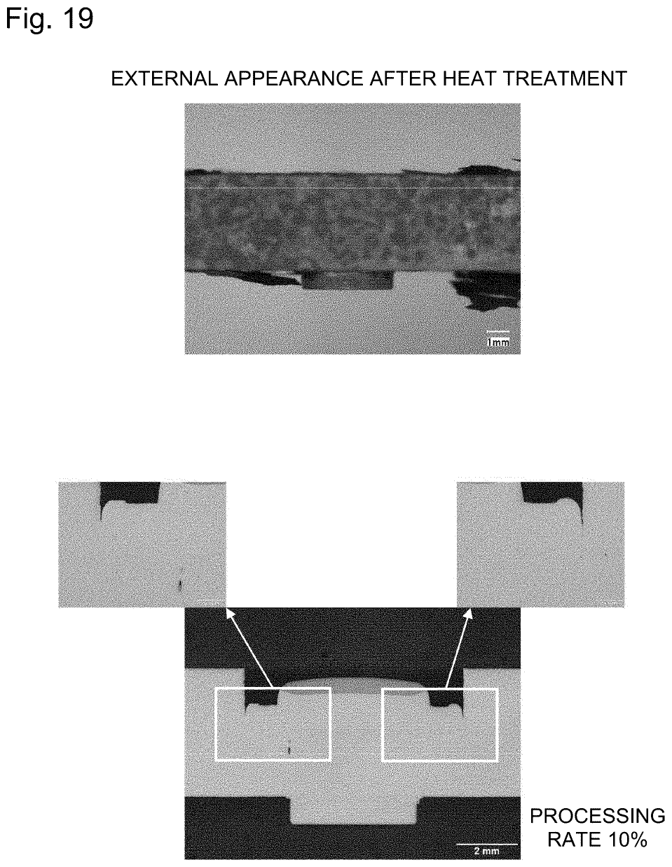

FIG. 19 shows the result of the heating test (500° C.×60 min) for the electric contact of Example 5. As a result of measuring the adhesion area ratio based on an oxide layer also for the electric contact in Example 5 after this heating test, the adhesion area ratio based on the oxide layer was 76.6%.

Example 6: In this example, a rivet contact having the following dimensions was manufactured in which the ratio (h/H) of the flange portion height of the rivet contact to the counterbore hole depth of the terminal member was 5. In addition, similar to Example 1, the rivet contact was inserted into the terminal member, and the lower end portion of the foot portion was pressurized/compressed while the head portion of the rivet contact was restrained. In these examples, the processing rate of the foot portion after compression was set to 10%.

### Rivet Contact

$$Head portion dimension : 5 mm in diameter \times 1 mm in height$$

$$Flange portion dimension : 7 mm in width ( W ) \times 1.1 mm in height ( H )$$

$$Foot portion dimension : 4 mm in diameter ( D ) \times 3 mm in length$$

$$W / D = 1.75$$

### Terminal Member

$$Overall dimension : 40 mm \times 16 mm , and 2.22 mm in thickness$$

$$Counterbore hole dimension : 7.1 mm in diameter \times 0.22 mm in depth ( h )$$

$$h / H = 5$$

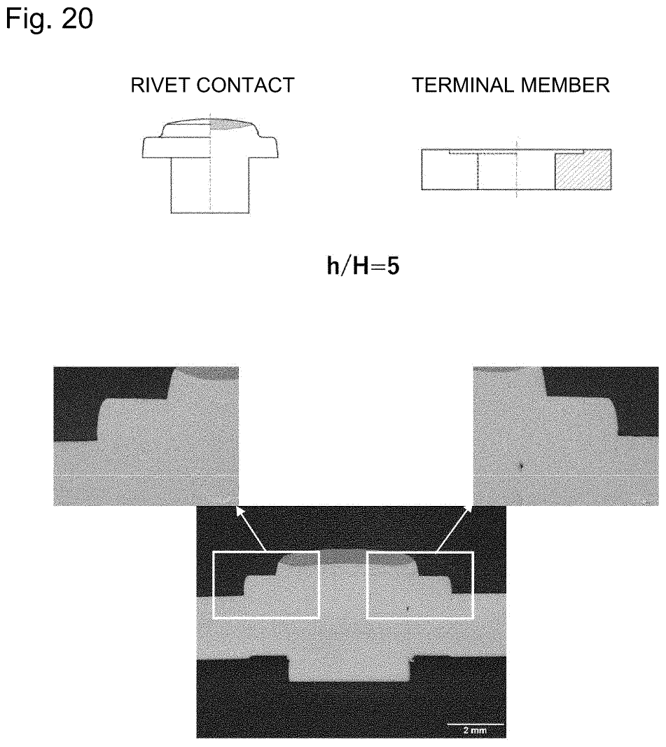

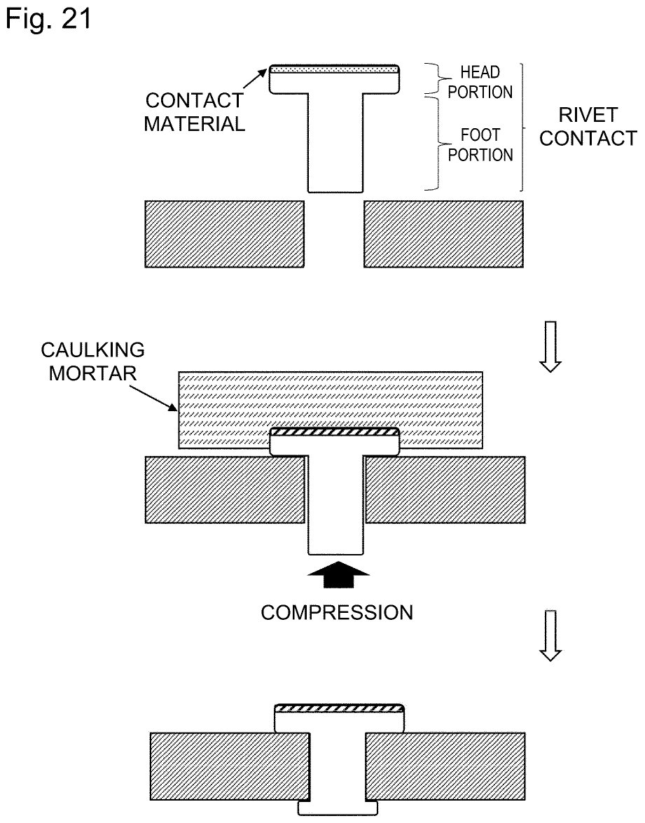

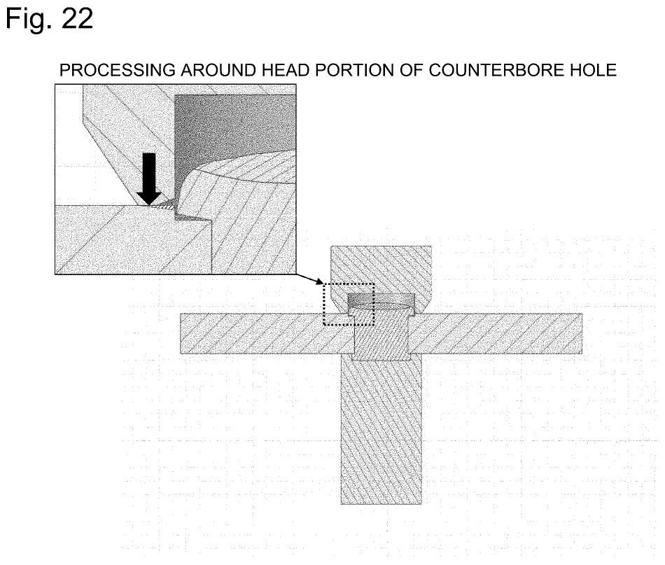

FIG. 20 shows photographs of a cross section of the electric contact and its partial enlargement in these examples. In this Example 6, it is deemed that the region where the flange portion and the counterbore hole contact with each other is in an adhesion state in its entire surface. The measurement result of the adhesion area ratio in the joining interface between the flange portion of the rivet contact and the counterbore hole was also 100%.

Table 1 below summarizes and illustrates the dimensions (W/D, h/H) and the adhesion area ratios of the electric contacts (the rivet contacts and the terminal members) of the above-described Example 1 to Example 6.

TABLE 1

| | | | Processing | Adhesion |
|---|---|---|---|---|
| | W/D | h/H | rate | area ratio |
| Example 1 | 1.75 | 1 | 90% | 95.0% (93.5%) |
| Example 2 | 1.1 | 1.1 | 30% | 85.7% |
| Example 3 | 4 | 1.5 | 10% | 99.5% (98.8%) |
| Example 4 | 1.75 | 0.5 | 20% | 85.0% |
| Example 5 | | | 10% | 71.7% (76.6%) |
| Example 6 | 1.75 | 5 | 10% | 100% |
| Comparative | — | — | 90% | 0% |
| example | | | | |

*The adhesion area ratios in parentheses of Examples 1, 3 and 5 are values based on oxide layers.

As illustrated above, each of the electric contacts of Example 1 to Example 6 demonstrates a high adhesion area ratio, has good adhesion between the rivet contact and the terminal member, and excellent heat dissipation can be expected. Additionally, although the electric contacts were heated at high temperature, and the adhesion area ratios based on the oxide layers at the joining interfaces were evaluated in Examples 1, 3 and 5, those values closely approximate the values of the adhesion area ratios based on the gaps observed at the joining interfaces. An oxide layer becomes an obstacle to heat transfer from a rivet contact to a terminal member. Since it is assumed that an electric contact of the present invention is applied to high-voltage high-current relays and the like that generate a large amount of heat, it is deemed that it is highly significant to confirm whether or not an oxide layer is formed. In addition, as described above, since observation of the oxide layer at the joining interface is easier than discovery/observation of the gap, measuring the area ratio of the oxide layer makes it possible to simply evaluate the adhesion.

### INDUSTRIAL APPLICABILITY

A rivet contact and an electric contact of the present invention can increase the adhesion between the rivet contact and a terminal member, and can dissipate the heat generated during driving of the electric contact more effectively than before. The present invention is useful not only for electric contacts mounted on common relays, switches, and the like, but also for electric contacts that generate a larger amount of heat, such as high-voltage high-current relays.

1. A rivet contact comprising a head portion containing a contact material in at least a part of an upper surface, and a foot portion inserted into a terminal member while supporting the head portion,
wherein a flange portion serving as a caulking margin and wider than the foot portion is formed between the head portion and the foot portion.

2. The rivet contact according to claim 1, wherein a ratio of a width W of the flange portion to a diameter D of the foot portion is 1.1 or more and 4 or less.

3. A combination of electric contact members comprising a rivet contact including a head portion containing a contact material in at least a part of a surface, and a foot portion inserted into a terminal member while supporting the head portion, and
the terminal member, having an insertion hole for the foot portion of the rivet contact inserted, fixing the rivet contact,
wherein, in the rivet contact, a flange portion serving as a caulking margin and wider than the foot portion is formed between the head portion and the foot portion, and
a counterbore hole for fitting the flange portion is formed in the terminal member.

4. The combination of the electric contact members according to claim 3, wherein a ratio of a width W of the flange portion to a diameter D of the foot portion of the rivet contact is 1.1 or more and 4 or less.

5. The combination of the electric contact members according to claim 3, wherein a ratio of a height h of the flange portion of the rivet contact to a depth H of the counterbore hole of the terminal member is 0.5 or more and 5 or less.

6. An electric contact, comprising:
a rivet contact including a head portion containing a contact material in at least a part of an upper surface, and a foot portion inserted into a terminal member while supporting the head portion, and
the terminal member, having an insertion hole for the foot portion of the rivet contact inserted, fixing the rivet contact,
the rivet contact being fixed to the terminal member with a lower end portion of the foot portion subjected to caulking processing after the foot portion is inserted into the insertion hole,
wherein, in the rivet contact, a flange portion serving as a caulking margin and wider than the foot portion is formed between the head portion and the foot portion,
a counterbore hole for fitting the flange portion is formed in the terminal member, and
the flange portion is fitted into and caulked to the counterbore hole.

7. The electric contact according to claim 6, wherein an adhesion area ratio in an arbitrary region in a joining interface between a side surface and a bottom surface of the flange portion of the rivet contact, and a side surface and a bottom surface of the counterbore hole is 50% or more.

8. A production method of an electric contact using the combination of the electric contact members defined in claim 2, the production method comprising:
a step of inserting the rivet contact into the terminal member; and
a step of performing plastic processing on a lower end portion of the foot portion and the flange portion of the rivet contact to fix the rivet contact to the terminal member.

9. The production method of an electric contact according to claim 8,
wherein, the step of performing plastic processing on the lower end portion of the foot portion and the flange portion of the rivet contact comprises compressing the lower end portion of the foot portion of the rivet contact while restraining the head portion and an upper surface of the flange portion of the rivet contact, thereby caulking the foot portion and caulking the flange portion to the counterbore hole of the terminal member.

10. The production method of an electric contact according to claim 8,
wherein, in the step of performing plastic processing on the lower end portion of the foot portion and the flange portion of the rivet contact,
a processing rate of the foot portion is set to 10% or more.

11. The production method of an electric contact according to claim 8, comprising:
after the step of fixing the rivet contact to the terminal member,
at least a step of performing compression processing on an upper surface of the flange portion of the rivet contact.

12. The combination of the electric contact members according to claim 4, wherein a ratio of a height h of the flange portion of the rivet contact to a depth H of the counterbore hole of the terminal member is 0.5 or more and 5 or less.

13. The production method of an electric contact according to claim 9,
wherein, in the step of performing plastic processing on the lower end portion of the foot portion and the flange portion of the rivet contact,
a processing rate of the foot portion is set to 10% or more.

14. The production method of an electric contact according to claim 9, comprising:
after the step of fixing the rivet contact to the terminal member,
at least a step of performing compression processing on an upper surface of the flange portion of the rivet contact.
